(19) United States
(12) Patent Application Publication
(10) Pub. No.: US 2016/0009554 A1
(43) Pub. Date: Jan. 14, 2016

(54) MOLTEN METAL GASIFIER

(71) Applicant: How Kiap GUEH, (US)

(72) Inventor: How Kiap Gueh, Singapore (SG)

(21) Appl. No.: 14/771,218

(22) PCT Filed: Feb. 28, 2014
(86) PCT No.: PCT/IB2014/059329

§ 371 Date: Aug. 28, 2015

(30) Foreign Application Priority Data
Feb. 28, 2013 (SG) 201301536-7

(51) Int. Cl. C01B 3/24; C10J 3/72; C01B 3/04; C10J 3/57

(52) U.S. Cl. CPC C01B 3/24; C10J 3/57; C10J 3/723; C01B 3/04; C10J 2300/123; C01B 2203/0272

(57) ABSTRACT

An apparatus for gasification of at least one feed fuel material containing carbon into syngas, under a total pressure which exceeds atmospheric pressure comprises a crucible means for containing molten metal, said crucible including injection means for injecting at least one feed fuel material, oxidant gas, or a combination thereof, beneath the surface of the molten metal, an exhaust pipe connected to said crucible means for discharge of syngas therefrom, cooling means for cooling said syngas connected to said exhaust pipe to form a sealed unit with said crucible means, and tapping means for discharge of slag from said crucible means.

The present application relates to an apparatus for production of syngas by gasification of carbon (contained in one or more feed fuel material), said apparatus being intended to work at increased pressure. More specifically the application relates to an apparatus for production of syngas by gasification of carbon in a molten metal into which carbon, oxygen or air (oxidant gas) are injected, carbon being injected in stoichiometric excess in relation to the oxidant gas in the melt. Syngas is then formed, substantially comprising carbon monoxide (CO) and hydrogen (H₂).

Since the early 1900's, efforts have been made to develop an efficient means to convert solid, carbon-containing reactants into liquid fuels. The early work in the field was performed in Germany in the years prior to and between the two world wars. In 1912-13, Frederick Bergius described the fundamental process for hydrogenating coal under very high pressure to yield liquid fuels. (Bergius was awarded a one-half share of the 1931 Nobel Prize in chemistry for this work. Carl Bosch, a titan of the German chemical field, was awarded the other half) Bergius' “direct liquefaction” of coal was used to produce liquid fuels in Germany during both world wars. A decade after Bergius' work, Franz Fischer and Hans Tropsch, while at the Kaiser Wilhelm Institute, developed the chemistry that now bears their names, and is sometimes referred to as “indirect liquefaction.” The general Fischer-Tropsch synthesis is a metal-catalyzed reaction to produce liquid hydrocarbons from a feedstock comprising hydrogen and carbon monoxide. The feedstock is universally referred to as synthesis gas, or simply “syngas.” The syngas itself is derived from the partial combustion of methane or from the gasification of coal or other biomass. The general reactions are as follows:

CH₄+1/2O₂→2H₂+CO

(2n+1)H₂+n CO→CₙH₂ₙ₊₂+nH₂O

The worldwide depression of the 1930's placed a severe economic strain on German companies' early efforts to build large-scale coal gasification plants. As the depression lingered on, crude oil prices plunged to 10 cents per barrel, resulting in a worldwide glut of cheap oil. Two developments, however, stemmed the collapse of the nascent goal gasification industry: (1) the rise of the Nazi government; and (2) the consolidation of the entire German chemical enterprise into an enormous, centrally-organized cartel (I. G. Farben). Begun in 1925, the formation and growth of I. G. Farben and its influence on the development of coal gasification technology can hardly be understated. Underwritten by the Nazi government, and backed by the full might of Germany's preeminent chemical and industrial prowess, German efforts to convert its coal riches into liquid fuel continued unabated throughout the 1930's.

These efforts were vastly expanded during the years of World War II (1939-1945), as Germany was increasingly denied access to sources of crude of. Synthetic liquid fuels produced from coal gasification accounted for roughly half of Germany's total production of fuel near the end of the war—124,000 barrels per day from 25 plants at its peak near the end of 1944. At that point, synthetic fuel accounted for 92% of Germany's aviation gasoline. (Intense allied bombing of German synthetic fuel plants began in earnest in late 1944 and early 1945. The results were immediate and fatal for the German war machine. In February 1945, Nazi Germany produced roughly a thousand tons of synthetic aviation gasoline—about one half of one percent of the level of the first four months of 1944. Hostilities in Europe ceased in May of 1945.) See U.S. Department of Energy, “The Early Days of Coal Research.”

After World War II, efforts to gasify coal and biomass stagnated as huge reserves of crude oil were discovered and exploited in the Middle East, Venezuela, Nigeria, and elsewhere. The formation of another cartel, the Organization of Petroleum Exporting Countries (OPEC), and its exercise of pricing power in crude oil markets rejuvenated the coal and biomass gasification field. Founded in 1960 by Iran, Iraq, Kuwait, Saudi Arabia and Venezuela (and later joined by Qatar, Indonesia, Libya, UAE, Algeria, Nigeria and Angola), OPEC did not rise to prominence until 1973, when the Arab members of OPEC instituted an oil embargo that sent crude oil prices skyrocketing. The Islamic fundamentalist revolution in Iran in 1979 sent crude oil prices briefly into the stratosphere ($100 per barrel when adjusted for inflation to January 2007). The mid-1980's, however, saw an equally dramatic drop in oil prices from their 1979 highs. Continued political instability in the middle east starting with the 1991 Gulf War, and extending to the panic caused by the Sep. 11, 2001 terrorist attacks in the U.S. (and the subsequent U.S. invasion and occupation of Iraq), coupled with the rapid industrialization of China and India, have combined to maintain current crude oil prices at very high levels.

From a technological standpoint, developments in coal and biomass gasification have proceeded along many fronts. For example, U.S. Pat. No. 2,459,550, issued Jan. 18, 1949, to A. J. Stamm, describes an apparatus for continuous destructive distillation of solids (principally wood in the form of sawdust or chips, and coal in the form of coal dust or pea-sized particles) in a bath of molten metal. The material to be gasified is carried between two finely porous, continuously looped screens that pass beneath the surface of a pool of liquid metal. The heat from the liquid metal is rapidly transferred to the material. Volatile compounds within the material are thereby vaporized, and the vapors pass through the porous screen, rise through the molten metal, and are then condensed. Both the resulting condensate and the charred solid material are then recovered. Similar, single-bath devices are described in U.S. Pat. Nos. 4,649,867; 4,925,532; and 5,693,188.

U.S. Pat. No. 3,647,379, issued Mar. 7, 1972, to Wenzel et al. describes a device for gasifying a coal/water mixture. The device is a single-chamber device in which dehydration of the coal is followed by gasification of the dried coal and then endothermic reaction of the resulting gas products.

U.S. Pat. No. 4,126,668, issued Nov. 21, 1978, to Erickson, describes a method to produce a hydrogen-rich gas such as pure hydrogen, ammonia synthesis gas, or methanol synthesis gas by reacting steam with a non-gaseous intermediate, whereby some of the steam is reduced to hydrogen and some of the intermediate is oxidized. Carbon dioxide may be added to (or substituted for) the steam, whereby carbon monoxide is produced in addition to (or in lieu of) H₂. The oxidized intermediate is reduced by a reducing gas. The reducing gas is generated by partially reforming a light hydrocarbon such as natural gas or naphtha with steam and/or CO₂, and than partially oxidizing the partially reformed gas with air. The low BTU exhaust gas resulting after reduction of the intermediate oxide is used as fuel for the primary reformer. When ammonia synthesis gas is produced by this process, the purge and flash gases from the ammonia synthesis loop are added to the reducing gas.

U.S. Pat. No. 4,344,773, issued Aug. 17, 1982, to Paschen et al. describes an apparatus for gasifying carbon-containing media. The device includes a molten iron both for gasifying the reactants and a plurality of nozzles for introducing the reactants into the molten iron bath. An outlet is also provided for removing slag from the bath. Because it uses molten iron, this device has distinct drawbacks. Melting the iron requires an extremely high reactor temperature. This, in turn, spawns other considerations. For example, the high temperature of the molten iron is extremely detrimental to the reactor lining. To ensure long lining life requires essentially zero motion of the iron melt. Likewise, the liquid slag is very difficult to handle due to the extreme temperatures involved. The process also is not energy efficient because it is hard to obtain a quality syngas at such high temperatures.

U.S. Pat. No. 4,345,990, issued Aug. 24, 1982, describes a continuous method for recovering oil and gas from carbon-containing material. The apparatus described here uses two molten-metal baths. No screens are utilized. Instead, the material to be gasified is placed directly into the bath. The first bath is a comparatively low-temperature bath maintained at about 500° C., while the second bath is maintained at a much higher temperature of about 1,200° C. Two different metals, substantially insoluble in each other when melted, are used in the two baths. Lead is the preferred metal for the first bath; iron is the preferred metal for the second bath. The reactant material is deposited into the first bath (molten lead), and the volatized gases are collected. The molten lead, with the partially distilled carbonaceous material within it, is then transferred to the second bath (molten iron). Here, oxygen is injected into the gas space above the molten iron. The carbonaceous material moves from the lead phase, to the iron phase, where it is further volatilized. The volatile gases liberated from the solids react with the oxygen in the headspace above the molten iron. The molten lead (which is not soluble in the molten iron) settles to the bottom of the second bath and is transferred back to the first vessel. Of particular note in this method is that the thermal decomposition in the first bath takes place in the absence of added oxygen, while oxygen is purposefully added in the second thermal decomposition. By recycling the lead that settles to the bottom of the second bath back into the first bath, the heat required to melt the iron is backward integrated to heat the lead too. In the second bath, the remaining amount of carbon in the solid reactant is gasified to syngas by adding a balanced amount of oxygen to the reaction (in the form of oxygen gas, air, oxides, etc.). Any remaining solids are removed as slag. The principal drawback of this device is that it requires pumping molten metals from bath-to-bath. Thus, the device has numerous mechanical parts that operate at extremely high temperatures.

U.S. Pat. No. 5,085,738, issued Feb. 4, 1992, to Harris et al. describes an apparatus for gasifying organic waste materials. The apparatus includes an elongated and inclined chamber filled with molten lead. Organic material introduced in a lower portion of the chamber migrates through the molten lead to a higher portion of the chamber due to the organic material having a specific gravity less than the molten lead. As the organic material migrates through the molten lead, the material is gasified. The resulting vapor-phase hydrocarbons are then captured in a condenser. The gaseous hydrocarbons are utilized to heat the lead in the chamber and the vapor is condensed to liquid hydrocarbons in the condenser. Residual solids flow to a reservoir connected to the chamber. This apparatus described here is intended for processing tire scraps and generally operates in the temperature range of 340° C., to 510° C. Other waste material can be used (such as wood and paper products). However, the pyrolysis products of woody biomass will have high amounts of heavy tar and char at this temperature range. The char would be difficult to manage in this single-chamber reactor apparatus. See also Published U.S. Patent Application 2005/0 131 260.

U.S. Pat. No. 5,478,370, issued Dec. 26, 1995, to Spangler describes a method for producing syngas from lower alkanes. In this approach, a molten metal oxide bath delivers oxygen to a feed stream containing lower alkanes. A reaction thus takes places wherein the lower alkanes are oxidized to produce carbon dioxide and the molten metal oxide is reduced to the elemental metal. The elemental metal is regenerated to the metal oxide by contact with a regenerant such as air. Heat from the molten baths is transferred to an endothermic reactor where a portion of the carbon dioxide-containing gas is converted to a mixture of carbon oxides and hydrogen.

U.S. Pat. No. 6,051,110, issued Apr. 18, 2000, to Dell'Orfano et al. describes a partially integrated, continuous process (and corresponding apparatus) to distill carbonaceous materials. In a fashion similar to the looped screens of the Stamm patent (see above), the Dell'Orfano patent uses mesh baskets to convey the carbonaceous material through the process. Using the baskets also eases recovery of the solid products that remain after gasification. In this approach, the carbon-containing reactants (preferably wood) are passed first through a de-gassing bath containing heated liquefied volatiles recovered from earlier runs (and referred to as “wood petrol” in the patent). The first bath degasses the wood without degrading the released gases. The de-gassed wood is then passed through a molten-metal bath (preferably molten lead), which converts the wood to char and volatiles. The volatiles are collected and a portion of them are recycled for use as the “wood petrol” in the first degassing bath. The remaining gases are collected. Lastly, the char is then passed through a condensing bath. Oxygen is specifically excluded from the second and third baths.

U.S. Pat. No. 6,110,239, issued Aug. 29, 2000, to Malone et al, describes a two-zone process in which a high-pressure hydrogen-rich gas stream and a high-pressure carbon monoxide-rich gas stream are simultaneously produced in separate zones using a molten-metal gasifier. Because the two gas streams are produced in separate zones, this approach eliminates the need to separate or compress the two gases. The process as described includes introducing a hydrocarbon feed into a molten metal bath beneath the molten metal surface in a first feed zone operating at a pressure above five (5) atmospheres absolute, which decomposing the hydrocarbon feed into a hydrogen-rich gas, and carbon. The carbon dissolves in the molten metal. The carbon concentration in the molten metal is carefully maintained to remain at or below the limit of solubility of carbon in the molten metal. A portion of the molten metal is then transferred from the feed zone to another molten metal oxidation zone operating at a pressure above five (5) atmospheres absolute into which an oxygen-containing material is introduced. The carbon dissolved in the metal reacts with the introduced oxygen to form a carbon monoxide-rich gas which leaves the oxidation zone. Thus, the carbon concentration in the molten metal is reduced, in this zone, the carbon concentration in the molten metal is controlled so that it does not reach the concentration at which the equilibrium oxygen concentration would exceed its solubility limit in the molten metal (in which instance a separate iron oxide phase would accumulate). A portion of the molten metal which has a lower carbon concentration from the oxidation zone is then recycled back to the feed zone. The two gas streams are passed out of their respective zones. The main disadvantage of this approach is that the concentration of carbon and oxygen in the two zones must be very carefully controlled, or CO will contaminate the H₂ gas stream. If the oxygen exceeds its solubility limit in the second zone of the molten metal, the oxygen will also react with the hydrocarbon in the first zone to create a CO impurity in the hydrogen-rich gases.

U.S. Pat. No. 6,663,681, issued Dec. 16, 2003, to Kindig et al. describes a method for producing hydrogen gas. The hydrogen gas is formed by reducing steam using a metal/metal oxide bath (e.g. iron/iron oxide) to remove oxygen from water. The steam is contacted with a molten metal mixture including a first reactive metal (iron) dissolved in a diluent metal (tin). The reactive metal oxidizes to the corresponding metal oxide, forming a hydrogen gas (via reduction). The metal oxide can then be reduced back to the metal for further production of hydrogen without substantial movement of the metal or metal oxide to a second reactor.

U.S. Pat. No. 6,830,597, issued Dec. 14, 2004, to Green, describes a process and device for gasifying biomass. In this approach, heat from a combustion chamber is used to gasify or liquefy biomass. The combustion chamber partially surrounds a reactor tube and is in direct thermal contact with the reactor tube. In this fashion, heat from the combustion chamber passes directly through the reactor wall to heat the biomass within the reactor tube,

U.S. Pat. No. 6,863,878, issued Mar. 8, 2005, to Klepper et al., describes a method of producing syngas from biomass or other carbonaceous material. The method utilizes a controlled devolatilization reaction in which the temperature of the feed material is maintained at less than 232° C. (450′ F.) until most of the available oxygen is consumed. The reaction is carried out at this very low temperature to minimize pyrolysis of the feed material. The method backward integrates the resulting syngas to provide the energy for the initial gasification reaction. The approach does required using high-pressure, high-temperature (1,000° C.) high-pressured steam to gasify the low-temperature biomass residues. This process is inefficient with respect to converting the carbon in the biomass reactant into syngas. The residual air combusts with the feedstock. The resulting energy is used to heat the biomass to the required temperature. That carbon is lost out the flue and is not converted to syngas.

Published U.S. Patent Application 2005/0 032 920, published Feb. 10, 2005, to Norbeck et al., describes a multi-step, integrated, steam pyrolysis apparatus for producing syngas for use as a gaseous fuel or as a feedstock for Fischer-Tropsch reactions. The process is described as “substantially self-sustaining.” Here, slurry of particles of carbonaceous material in water, and hydrogen, is fed into a hydro-gasification reactor under conditions that yield a methane-containing product gas. This methane-containing gas is then fed into a steam pyrolytic reformer to yield syngas. A portion of the hydrogen generated by the steam pyrolytic reformer is fed through a hydrogen purification filter and backward integrated into the hydro-gasification reactor used in the first step. The remaining synthesis gas generated by the steam pyrolytic reformer can be used directly as a fuel. Alternatively, the syngas may be fed into a Fischer-Tropsch reactor to produce liquid fuels. Molten salt loops are used to transfer heat from the hydro-gasification reactor (and the Fischer-Tropsch reactor if a liquid fuel is produced), to the steam generator and the steam pyrolytic reformer.

Very recently, a paper appeared in the Proceedings of the National Academy of Sciences, Agrawal, Singh, Ribeiro & Delgass (Mar. 14, 2007) “Sustainable Fuels for the Transportation Sector,” PNAS, doi: 10.1073/pnas.0609921104. This paper presents a much generalized scheme for producing liquid fuels by producing hydrogen (H₂) from carbon-free primary energy source, e.g., solar, nuclear, wind. The hydrogen so produces is then reacted with gasified solids, such as coal or biomass. The overall goal is the complete incorporation of every carbon atom present in the reactant into a molecule of liquid fuel product. Carbon dioxide produced in the biomass gasification step is constantly recycled into the reactor, thus eliminating the release of carbon dioxide into the atmosphere. It must be noted, however, that the paper sets forth only a conceptual framework. As the authors themselves state, the chemical processing systems to accomplish the process “are yet to be defined.”

It is an object to provide an improved device and an improved method for for gasification of at least one feed fuel material containing carbon into syngas.

This object and other object are solved by the subject matter of the application.

The application provides an apparatus for gasification of at least one feed fuel material containing carbon into syngas, under a total pressure which exceeds atmospheric pressure, wherein at least a portion of syngas is intended for conversion into electrical power, mechanical shaft power, one or more Fischer-Tropsch products, carbon dioxide, hydrogen, derivatives thereof, or combinations thereof.

The apparatus comprises a crucible for containing molten metal, said crucible including injection means for injecting at least one feed fuel material, oxidant gas, or a combination thereof, beneath the surface of the molten metal. An exhaust pipe is connected to said crucible for discharge of syngas therefrom and there is a cooling system provided for cooling said syngas, which is connected to said exhaust pipe to form a sealed unit with said crucible means, in order to maintain an overpressure.

Tapping means, e.g. in the form of a tap pipe, are provided for discharge of slag from said crucible, and one or more induction coil is provided for inductively heating molten metal disposed within the crucible means. A power supply circuit energizes the one or more induction coil with an alternating current (AC) power with a pre-determined waveform, wherein the power supply circuit is adapted to provide an alternating current (AC) with a frequency of between 50 Hz to less than a few kHz.

A process for gasification of at least one feed fuel material containing carbon into syngas, under total pressure exceeding atmospheric pressure, wherein at least a portion of syngas is converted to electrical power, mechanical shaft power, one or more Fischer-Tropsch products, carbon dioxide, hydrogen, derivatives thereof, or combinations thereof, comprises
melting a metal charge material into molten metal by electromagnetic induction heating, disposed within a crucible,
electromagnetically coupling molten metal with at least one induction coil supplied with alternating current (AC) power waveform having an alternating voltage frequency range of between 50 Hz to 1000 Hz, or 100 Hz to 800 Hz, or 150 Hz to 600 Hz, or 50 Hz to 4 kHz, or 300 Hz to 6 kHz, or 120 Hz to 4.8 kHz, or a combination thereof, to cause molten metal to have an operating temperature range of between 900 degrees Celsius to 2,000 degrees Celsius,
delivering feed fuel material, oxidant gas, or in combination, into contact with at least a portion of molten metal to convert at least a portion of feed fuel material into syngas,
withdrawing molten slag formed during the step of (c) from at least a portion of molten metal,
placing molten slag withdrawn into contact with a primary cooling fluid having a temperature range of between 15 degrees Celsius to 40 degrees Celsius and recirculating any exhaust gas formed back into contact with at least a portion of molten metal disposed within crucible.

The application will be further described with reference to various embodiments shown in the attached drawings, where

FIG. 1 is an illustration of the present invention.

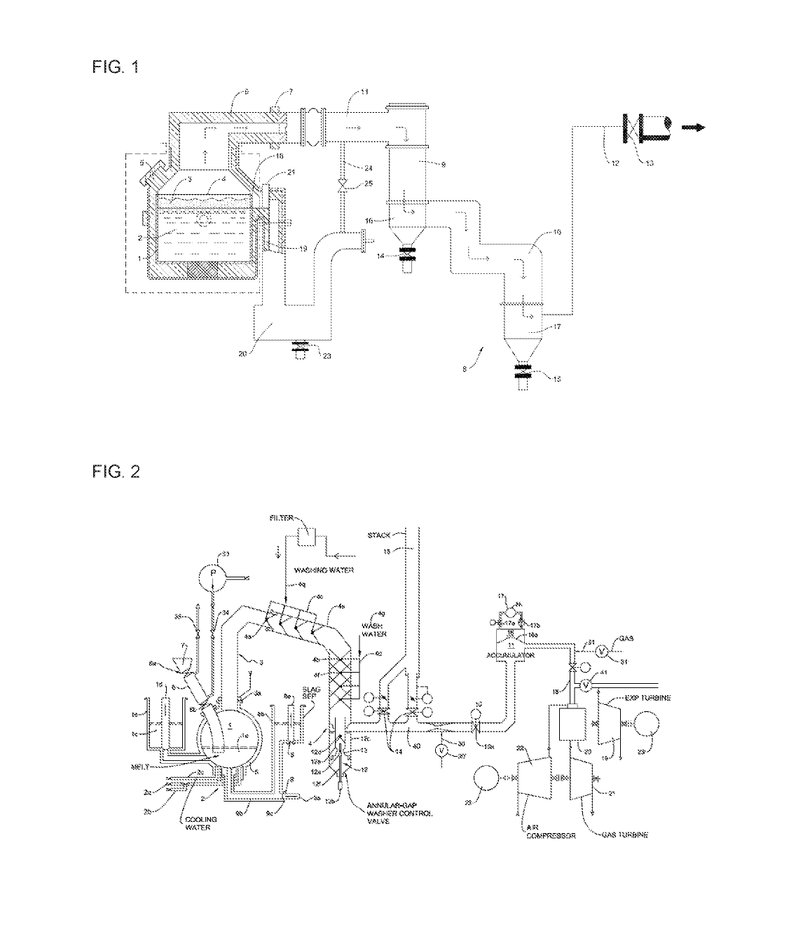

FIG. 2 is a schematic diagram another variation of the present invention.

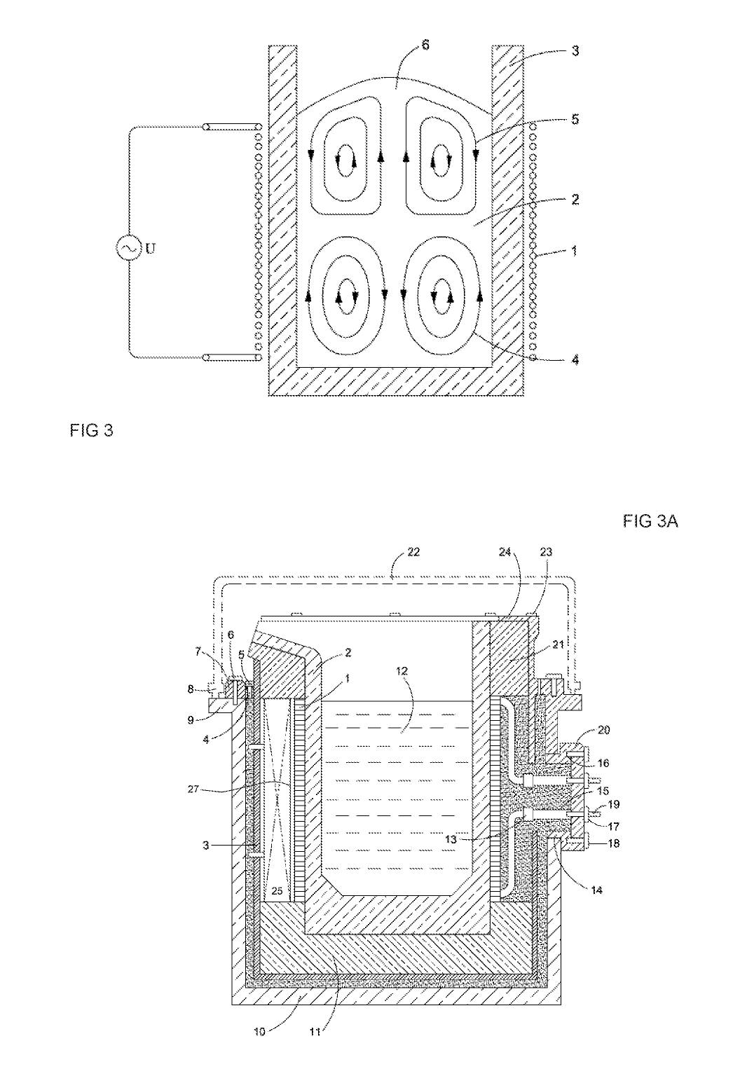

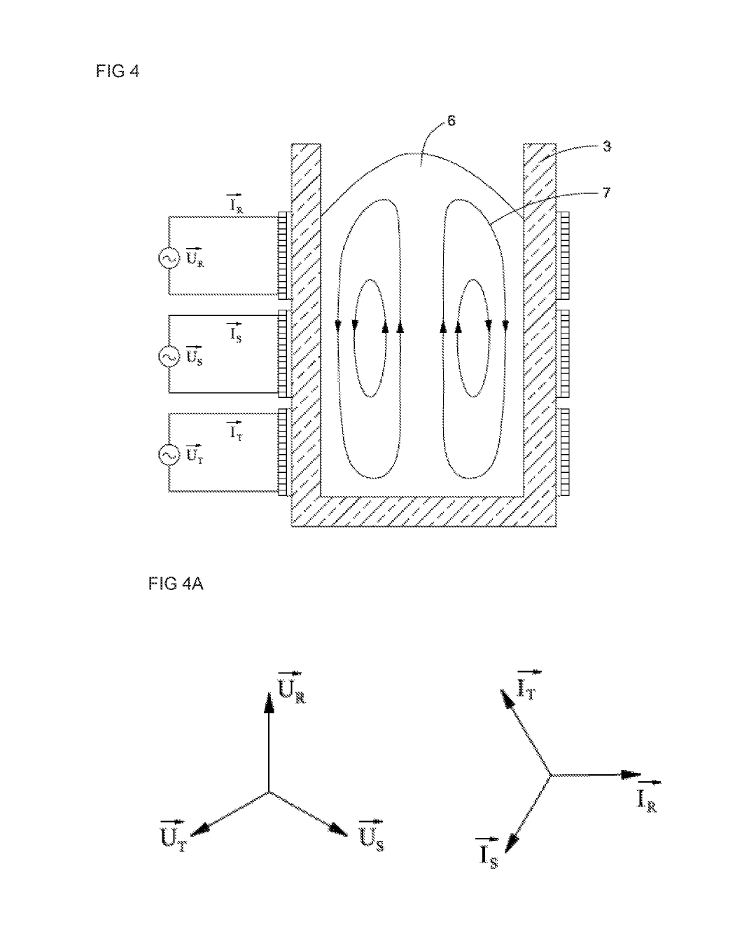

FIG. 3 and FIG. 4 are sectional views of a gasifier furnace embodying the principles of the present invention.

FIG. 3A is a sectional view of the gasifier furnace embodying the principles of the present invention.

FIG. 3 is a series of vector diagrams.

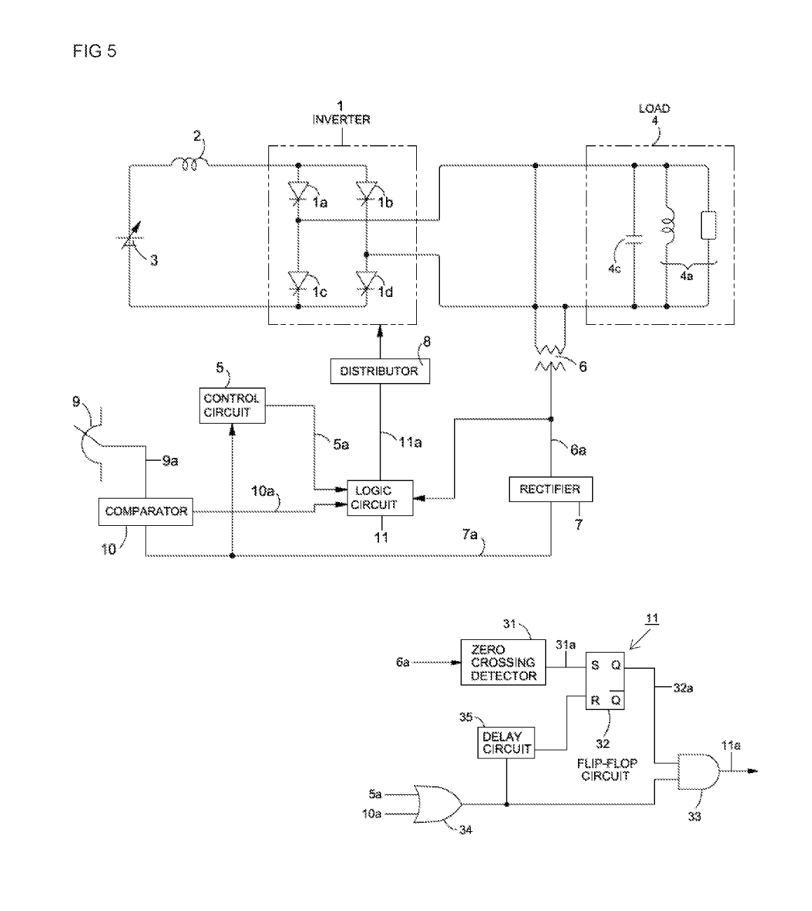

FIG. 5 is a diagram showing an inverter system with a control system of an embodiment of the invention.

FIG. 6 is a block diagram showing an internal construction of an example of the logic circuit 11 shown in FIG. 5.

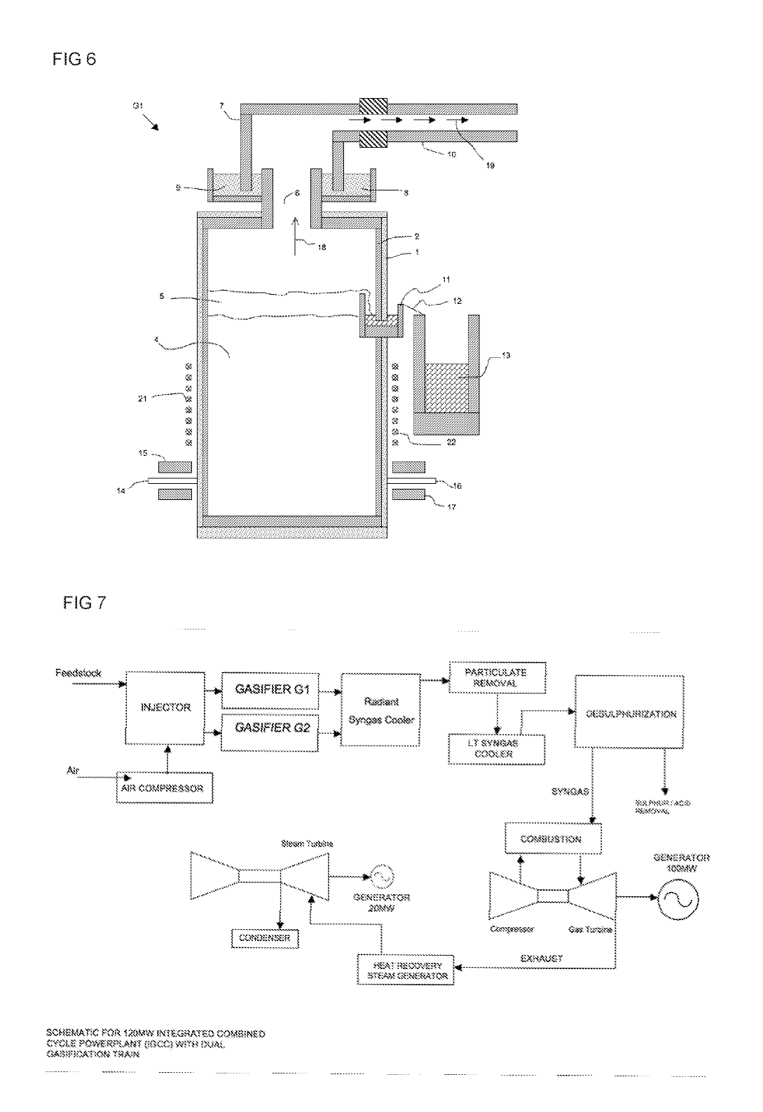

FIG. 7 is a cross section drawing of another embodiment of the gasifier furnace.

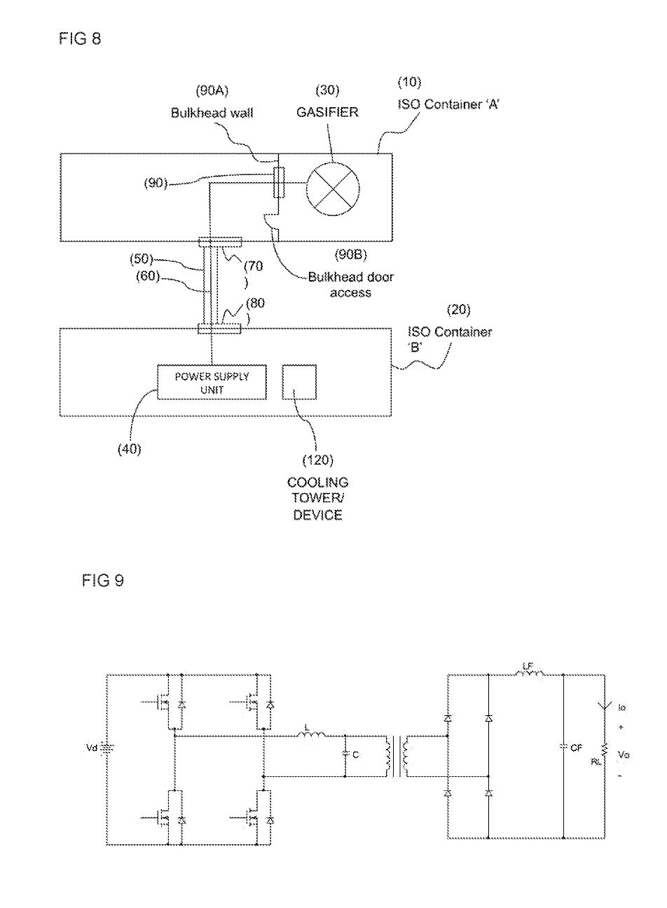

FIG. 8 is a schematic drawing of the gasifier plant.

FIG. 9 is a circuit topology of a PRC power supply.

Approximating language, as used herein throughout the specification and claims, may be applied to modify any quantitative representation that could permissibly vary without resulting in a change in the basic function to which it is related. Accordingly, a value modified by a term or terms, such as “about,” is not limited to the precise value specified. In some instances, the approximating language may correspond to the precision of an instrument for measuring the value. In some instances, the term about can denote a value within a range of ±10% of the quoted value.

Terms “heating value,” “calorific value,” and “caloric value,” are interchangeably used within this description.

“Inverter”, “converter”, “inverter circuit”, “converter circuit”, as used herein throughout the specification and claims, may refer to an electrical circuit arrangement of electrical and or electronic components that changes an input power source (either A.C. “alternating current”, or D.C. “direct current”) into a converted A.C. power output at a required voltage, current, frequency and phase. The electrical circuit arrangement may comprise of one or more induction coil, capacitors, resistors, power switching components, electric motors, electric power generators, microprocessors, solid state semiconductors, transformers, diodes, half-bridge rectifiers, full-bridge rectifiers, pulse wave modulators (PWM), electronic oscillator, configured in series, parallel, or series-parallel circuit topologies.

“Feed”, “feed fuel”, “feedstock”, as used herein throughout the specification and claims, may refer to coal, biomass, municipal solid waste, refuse-derived fuel (RDF), industrial waste, sewage, raw sewage, peat, scrap rubber, shale ore, tar sands, crude oil, natural gas, low-BTU blast furnace off-gas, flue gas exhaust, or a combination thereof.

Refuse-derived fuel (RDF), which is generally produced by shredding municipal solid waste, consists largely of organic components of municipal waste such as plastics and biodegradable waste. Non-combustible materials such as glass and metals are removed mechanically and the resultant material compressed into pellets, bricks, or logs and used for conversion to combustible gas, which can itself be used for electricity generation or the like,

Feed fuel material, feedstocks, can also mean agricultural feedstocks, forestry-based feedstocks, municipal solid waste (MSW), MSW can include the following: selected from the group consisting of waste plastics, used tires, paper, scrap-wood, food-processing waste, sewage, sludge, green-waste.

Feed fuel material, feedstocks can also mean fossil material such as crude oil, tar sands, shale oil, coal, natural gas, and combinations thereof,

Feed fuel material, feedstocks can also mean coal mine tailings, coal waste, coal fines, coal-water slurry, coal-liquid mixtures, and combinations thereof.

Feed fuel material, feedstocks can also mean refinery residual material comprises low-value carbonaceous by-products selected from the group consisting of asphaltenes, tars, and combinations thereof.

Flue gas exhaust also refers to gas containing CO, CO.sub.2 (carbon dioxide), nitrogen, nitrogen oxides and other particulates, sulphur compounds, soot, tar, or combustion exhaust gases generated from fossil-fuel power plants such as oil, coal, gas-fired powerplants, boilers, steam generators, combustion burners, gas turbine exhausts, reciprocating engine exhaust gases.

Fischer-Tropsch (“F-T”) products, include refinery/petrochemical feedstocks, transportation fuels, synthetic crude oil, liquid fuels, lubricants, alpha olefins, waxes, and the like. The F-T reaction can be carried out in any type reactor, for example, through the use of fixed beds; moving beds; fluidized beds; slurries; bubbling beds, or any combination thereof. The F-T reaction can employ one or more catalysts including, but not limited to, copper-based; ruthenium-based; iron-based; cobalt-based; mixtures thereof, or any combination thereof. The F-T reaction can be carried out at temperatures ranging from about 190° C. (374° F.) to about 450° C. (842° F.) depending on the reactor configuration. Additional reaction and catalyst details can be found in U.S. 2005/0284797 and U.S. Pat. Nos. 5,621,155; 6,682,711; 6,331,575; 6,313,062; 6,284,807; 6,136,868; 4,568,663; 4,663,305; 5,348,982; 6,319,960; 6,124,367; 6,087,405; 5,945,459; 4,992,406; 6,117,814; 5,545,674, and 6,300,268.

Fischer-Tropsch products including liquids which can be further reacted and/or upgraded to a variety of finished hydrocarbon products. Certain products, e.g. C4-C5 hydrocarbons, can include high quality paraffin solvents which, if desired, can be hydrotreated to remove olefinic impurities, or employed without hydrotreating to produce a wide variety of wax products. Liquid hydrocarbon products, containing C16 and higher hydrocarbons can be upgraded by various hydroconversion reactions, for example, hydrocracking, hydroisomerization, catalytic dewaxing, isodewaxing, or combinations thereof. The converted C16 and higher hydrocarbons can be used in the production of mid-distillates, diesel fuel, jet fuel, isoparaffinic solvents, lubricants, drilling oils suitable for use in drilling muds, technical and medicinal grade white oil, chemical raw materials, and various hydrocarbon specialty products.

Commodity chemicals including, but not limited to, acetic acid, phosgene, isocyanates, formic acid, propionic acid, mixtures thereof, derivatives thereof, and/or combinations thereof, ammonia, using the Haber-Bosch process described in LeBlanc et al in “Ammonia,” Kirk-Othmer Encyclopedia of Chemical Technology, Volume 2, 3rd Edition, 1978, pp., 494-500. In one or more embodiments, synthesis gas, or commodity chemicals or F-T products or a combination thereof can be used for the production of alkyl-formates, for example, the production of methyl formate. Any of several alkyl-formate production processes can be used, for example a gas or liquid phase reaction between carbon monoxide and methanol occurring in the presence of an alkaline, or alkaline earth metal methoxide catalyst. Additional details can be found in U.S. Pat. Nos. 3,716,619; 3,816,513; and 4,216,339.

In one or more embodiments, a reaction device can be used to produce methanol, dimethyl ether, ammonia, acetic anhydride, acetic acid, methyl acetate, acetate esters, vinyl acetate and polymers, ketenes, formaldehyde, dimethyl ether, olefins, derivatives thereof, or combinations thereof. For methanol production, for example, the Liquid Phase Methanol Process can be used (LPMEOH™). In this process, at least a portion of the carbon monoxide in the syngas can be directly converted into methanol using a slurry bubble column reactor and catalyst in an inert hydrocarbon oil reaction medium. The inert hydrocarbon oil reaction medium can conserve heat of reaction while idling during off-peak periods for a substantial amount of time while maintaining good catalyst activity.

Additional details can be found in U.S. 2006/0149423 and prior published Heydorn, E. C., Street, B. T., and Kornosky, R. M., “Liquid Phase Methanol (LPMEOH™) Project Operational Experience,” (Presented at the Gasification Technology Council Meeting in San Francisco on Oct. 4-7, 1998). Gas phase processes for producing methanol can also be used. For example, known processes using copper based catalysts, the Imperial Chemical Industries process, the Lurgi process and the Mitsubishi process can be used.

In one or more embodiments, the hydrogen-rich product can be used in one or more downstream operations, including, but not limited to, hydrogenation processes, fuel cell energy processes, ammonia production, and/or hydrogen fuel. For example, the hydrogen-rich product can be used to make hydrogen fuel using one or more hydrogen fuel cells. In one or more embodiments, at least a portion of the syngas can be combined with one or more oxidants and combusted in one or more combustors to provide a high pressure/high temperature exhaust gas.

The exhaust gas can be passed through one or more turbines and/or heat recovery devices to provide mechanical power, electrical power and/or steam. In one or more embodiments, the exhaust gas can be introduced to one or more gas turbines to provide an exhaust gas and mechanical shaft power to drive the one or more electric generators. In one or more embodiments, the exhaust gas can be introduced to one or more heat recovery systems to provide steam. In one or more embodiments, a first portion of the steam can be introduced to one or more steam turbines to provide mechanical shaft power to drive one or more electric generators. In one or more embodiments, a second portion of the steam can be introduced to the gasifier, and/or other auxiliary process equipment. In one or more embodiments, lower pressure steam from the one or more steam turbines can be recycled to the one or more heat recovery systems. In one or more embodiments, residual heat can be rejected to a condensation system well known to those skilled in the art or sold to local industrial and/or commercial steam consumers.

In one or more embodiments, the heat recovery system can be a closed-loop heating system, e.g. a waste heat boiler, shell-tube heat exchanger, and the like, capable of exchanging heat between the exhaust gas and the lower pressure steam to produce steam. In one or more embodiments, the heat recovery system can provide up to 17,350 kPa (2,500 psig), 855° C. (1,570° F.) superheated steam without supplemental fuel.

Coal refers to a common fossil fuel, the most common classification is based on the calorific value and composition of the coal.

Coal is of importance as a fuel for power generation now and in the future since there are a lot of coal reserves, and the coal reserves are hardly unevenly distributed over the world.

ASTM (American Society for Testing and Materials) standard D388 classifies the coals by rank. This is based on properties such as fixed carbon content, volatile matter content, calorific value and agglomerating character.

Broadly, the coals can be categorized as “high rank coal” and “low rank coal,” which denote high-heating-value, lower ash content and lower heating value, higher ash content coals, respectively.

Low-rank coals include lignite and sub-bituminous coals. These coals have lower energy content and higher moisture levels.

High-rank coals, including bituminous and anthracite coals, contain more carbon than lower-rank coals and correspondingly have a much higher energy content. Some coals with intermediate properties may be termed as “medium rank coal.”

The term biomass covers a broad range of materials that offer themselves as fuels or raw materials and are characterized by the fact that they are derived from recently living organisms (plants and animals).

This definition clearly excludes traditional fossil fuels, since although they are also derived from plant (coal) or animal (oil and gas) life, it has taken millions of years to convert them to their current form.

Thus the term biomass includes feeds derived from material such as wood, woodchips, sawdust, bark, seeds, straw, grass, and the like, from naturally occurring plants or purpose grown energy crops.

It includes agricultural and forestry wastes. Agricultural residue and energy crops may further include husks such as rice husk, coffee husk etc., maize, corn stover, oilseeds, cellulosic fibers like coconut, jute, and the like.

Agricultural residue also includes material obtained from agro-processing industries such as deoiled residue, gums from oil processing industry, bagasse from sugar processing industry, cotton gin trash and the like. It also includes other wastes from such industries such as coconut shell, almond shell, walnut shell, sunflower shell, and the like.

In addition to these wastes from agro industries, biomass may also include wastes from animals and humans.

In some embodiments, the biomass includes municipal waste or yard waste, sewage sludge and the like. In some other embodiments, the term biomass includes animal farming byproducts such as piggery waste or chicken litter. The term biomass may also include algae, microalgae, and the like.

Thus, biomass covers a wide range of material, characterized by the fact that they are derived from recently living plants and animals. All of these types of biomass contain carbon, hydrogen and oxygen, similar to many hydrocarbon fuels; thus the biomass can be used to generate energy.

As discussed in a previous section, biomass includes components such as oxygen, moisture and ash and the proportion of these depends on the type and source of the biomass used.

Due to presence of these components, the gasification characteristics of biomass are much different than that of coal. Due the presence of these components that do not add to heating value, the calorific vale of biomass is much lower than that of coal. The calorific value and composition of biomass also depend on other factors such as seasonal and geographical variability.

### Additional Definitions

An “oil refinery,” as defined herein, generally refers to an oil refinery, or aspects thereof, where crude oil (or other fossil fuels such as coal or natural gas) is processed. Processes carried out at such refineries include, but are not limited to, reforming, cracking, distilling, and the like.

“Refinery residual,” or “refinery resid,” as defined herein, generally refers to the heaviest by-product fractions produced at a refinery. Asphaltenes are a type of refinery resid, as is coker coke.

A “gasifier,” as defined herein, refers to a reaction environment wherein a carbon carrying feedstock material is converted into a gas through the action of heat and, possibly, one or more reactive gases such as oxygen, air, carbon dioxide (CO2), and/or steam. Gasifier can mean partial oxidation gasifier, a steam reformer, an autothermal reformer, and combinations thereof. Gasifier can mean a downdraft type gasifier, a cross-draft type gasifier, a fluidized bed type gasifier (or fluid bed), a moving bed type gasifier, a entrained flow type gasifier, a molten bed type gasifier, and combinations thereof. A molten bed type gasifier means a gasifier having a melt, molten metal, molten metal alloy, liquid akali-metal, or combinations as at least a port of the reaction environment, and such melt being disposed within or in proximity to the gasifier, feed delivered into fluid contact with the melt to cause at least a portion of the feed to be converted into syngas.

“Synthesis gas,” or “syngas,” as defined herein, generally refers to a mixture of carbon monoxide (CO) and hydrogen (H2) produced by gasification in a gasifier.

A “crucible” as defined herein, refers to a container having a hollow interior wherein at least a portion of the reaction environment of the gasifier occupies. Molten metal, in the case of a molten metal gasifier, is disposed within the hollow interior. In fluidized bed gasifiers, plasma-type gasifiers, the hollow interior fluidly interfaces with at least a portion of the gasifier's reaction environment.

A “melt”, “molten metal”, “molten metal bath”, “melt bath”, “liquid metal”, “liquid metal bath”, “liquid metal” as defined herein, generally refers to a molten metal in its melted state, or a metallic material wherein at least a portion of the metallic material is melted to its liquid state.

### Detailed Description of the Embodiments of the Present Invention

The feed fuel material can be one or more carbon-based and/or carbon-containing materials whether solid, liquid, gas, or any combination thereof. The feed fuel material can include, but is not limited to, biomass (i.e., plant and/or animal matter or plant and/or animal derived matter); coal (including anthracite, bituminous, sub-bituminous and lignite); rubber-derived materials; oil shale; coke; tar; asphaltenes; landfill waste derived material; sewage derived material; flue gas exhaust, low-BTU gas, engine exhaust gas, incinerator exhaust gas, combustion burner equipped boiler exhaust gas, low ash or no ash polymers; hydrocarbon-based polymeric materials; biomass derived material; or by-product derived from manufacturing operations.

Flue gas exhaust also refers to gas containing CO, CO.sub.2 (carbon dioxide), nitrogen, nitrogen oxides and other particulates, sulphur compounds, soot, tar, or combustion exhaust gases generated from fossil-fuel power plants such as oil, coal, gas-fired powerplants, boilers, steam generators, combustion burners, gas turbine exhausts, reciprocating engine exhaust gases.

The hydrocarbon-based polymeric materials can include, but is not limited to, thermoplastics, elastomers, rubbers, including polypropylenes, polyethylenes, polystyrenes, including other polyolefins, homo polymers, copolymers, block copolymers, and blends thereof, PET (polyethylene terephthalate), poly blends, poly-hydrocarbons containing oxygen; heavy hydrocarbon sludge and bottoms products from petroleum refineries and petrochemical plants such as hydrocarbon waxes, blends thereof, derivatives thereof, and combinations thereof. In one or more embodiments, the feed fuel material can include one or more of the above listed materials. Accordingly, the process can be useful for accommodating mandates for proper disposal of previously manufactured materials.

In at least one specific embodiment the feed fuel material can be suspended, slurried or otherwise conveyed by the carrier fluid and gasified in the gasification zone within the molten metal or molten iron disposed within the crucible of the present application to provide a syngas containing hydrogen, carbon monoxide, and carbon dioxide. At least a portion of the syngas can be used to produce electrical power, hydrogen, and/or commodity chemicals such as Fischer-Tropsch (“F-T”) products, hydrogen, carbon monoxide and/or carbon dioxide.

Fischer-Tropsch (“F-T”) products, include refinery/petrochemical feedstocks, transportation fuels, synthetic crude oil, liquid fuels, lubricants, alpha olefins, waxes, and the like. The F-T reaction can be carried out in any type reactor, for example, through the use of fixed beds; moving beds; fluidized beds; slurries; bubbling beds, or any combination thereof. The F-T reaction can employ one or more catalysts including, but not limited to, copper-based; ruthenium-based; iron-based; cobalt-based; mixtures thereof, or any combination thereof. The F-T reaction can be carried out at temperatures ranging from about 190° C. (374° F.) to about 450° C. (842° F.) depending on the reactor configuration. Additional reaction and catalyst details can be found in U.S. 2005/0284797 and U.S. Pat. Nos. 5,621,155; 6,682,711; 6,331,575; 6,313,062; 6,284,807; 6,136,868; 4,568,663; 4,663,305; 5,348,982; 6,319,960; 6,124,367; 6,087,405; 5,945,459; 4,992,406; 6,117,814; 5,545,674, and 6,300,268.

Fischer-Tropsch products including liquids which can be further reacted and/or upgraded to a variety of finished hydrocarbon products. Certain products, e.g. C4-C5 hydrocarbons, can include high quality paraffin solvents which, if desired, can be hydrotreated to remove olefinic impurities, or employed without hydrotreating to produce a wide variety of wax products. Liquid hydrocarbon products, containing C16 and higher hydrocarbons can be upgraded by various hydroconversion reactions, for example, hydrocracking, hydroisomerization, catalytic dewaxing, isodewaxing, or combinations thereof. The converted C16 and higher hydrocarbons can be used in the production of mid-distillates, diesel fuel, jet fuel, isoparaffinic solvents, lubricants, drilling oils suitable for use in drilling muds, technical and medicinal grade white oil, chemical raw materials, and various hydrocarbon specialty products.

Commodity chemicals including, but not limited to, acetic acid, phosgene, isocyanates, formic acid, propionic add, mixtures thereof, derivatives thereof, and/or combinations thereof, ammonia, using the Haber-Bosch process described in LeBlanc et al in “Ammonia,” Kirk-Othmer Encyclopedia of Chemical Technology, Volume 2, 3rd Edition, 1978, pp., 494-500. in one or more embodiments, synthesis gas, or commodity chemicals or F-T products or a combination thereof can be used for the production of alkyl-formates, for example, the production of methyl formate. Any of several alkyl-formate production processes can be used, for example a gas or liquid phase reaction between carbon monoxide and methanol occurring in the presence of an alkaline, or alkaline earth metal methoxide catalyst. Additional details can be found in U.S. Pat. Nos. 3,716,619; 3,816,513; and 4,216,339.

In one or more embodiments, a reaction device can be used to produce methanol, dimethyl ether, ammonia, acetic anhydride, acetic acid, methyl acetate, acetate esters, vinyl acetate and polymers, ketenes, formaldehyde, dimethyl ether, olefins, derivatives thereof, or combinations thereof. For methanol production, for example, the Liquid Phase Methanol Process can be used (LPMEOH™). In this process, at least a portion of the carbon monoxide in the syngas can be directly converted into methanol using a slurry bubble column reactor and catalyst in an inert hydrocarbon oil reaction medium. The inert hydrocarbon oil reaction medium can conserve heat of reaction while idling during off-peak periods for a substantial amount of time while maintaining good catalyst activity.

Additional details can be found in U.S. 2006/0149423 and prior published Heydorn, E. C., Street, B. T., and Kornosky, R, M., “Liquid Phase Methanol (LPMEOH™) Project Operational Experience,” (Presented at the Gasification Technology Council Meeting in San Francisco on Oct. 4-7, 1998). Gas phase processes for producing methanol can also be used. For example, known processes using copper based catalysts, the Imperial Chemical Industries process, the Lurgi process and the Mitsubishi process can be used.

In one or more embodiments, the hydrogen-rich product can be used in one or more downstream operations, including, but not limited to, hydrogenation processes, fuel cell energy processes, ammonia production, and/or hydrogen fuel. For example, the hydrogen-rich product can be used to make hydrogen fuel using one or more hydrogen fuel cells, in one or more embodiments, at least a portion of the syngas can be combined with one or more oxidants and combusted in one or more combustors to provide a high pressure/high temperature exhaust gas.

The exhaust gas can be passed through one or more turbines and/or heat recovery devices to provide mechanical power, electrical power and/or steam. In one or more embodiments, the exhaust gas can be introduced to one or more gas turbines to provide an exhaust gas and mechanical shaft power to drive the one or more electric generators. In one or more embodiments, the exhaust gas can be introduced to one or more heat recovery systems to provide steam. In one or more embodiments, a first portion of the steam can be introduced to one or more steam turbines to provide mechanical shaft power to drive one or more electric generators. In one or more embodiments, a second portion of the steam can be introduced to the gasifier, and/or other auxiliary process equipment. In one or more embodiments, lower pressure steam from the one or more steam turbines can be recycled to the one or more heat recovery systems. In one or more embodiments, residual heat can be rejected to a condensation system well known to those skilled in the art or sold to local industrial and/or commercial steam consumers.

In one or more embodiments, the heat recovery system cooler) can be a closed-loop heating system, e.g. a waste heat boiler, shell-tube heat exchanger, and the like, capable of exchanging heat between the exhaust gas and the lower pressure steam to produce steam. In one or more embodiments, the heat recovery system can provide up to 17,350 kPa (2,500 psig), 855° C. (1,570° F.) superheated steam without supplemental fuel.

### EXAMPLE 1

FIG. 1 shows a crucible 1, which during operation contains a molten iron melt 2. In FIG. 1, 3 represents slag floating on top of the molten iron melt. The crucible 1 is optionally designed to be tilted round an axis 4 for discharge of molten iron melt 2 through opening 5 in the event where crucible repair or inspection is required.

Carbon contained in one or more feed fuel material, oxidant gas such as air, oxygen, and slag-forming compounds are injected by means of conventional lances and/or injection pipes (not shown).

In the top of the crucible 1 there is an exhaust gas pipe 6 for the syngas produced, which is connected by a gas-tight coupling 7 to a device in the direction in which the syngas is transported. This device comprises a cooler (“heat recovery system”), generally represented by 8, which according to this embodiment comprises two conventional steam boilers 9, 10.

The syngas produced is thus led through the pipe 6 and another pipe 11 to the first boiler 9. The gas is then led to the second of the two boilers, 10, and on to a discharge pipe 12.

The discharge pipe is provided with a regulating valve 13 for controlling and maintaining the pressure in the crucible and the cooler 8. The regulating valve 13 is of any suitable kind.

As the syngas in the outlet pipe 12 has a considerably lower temperature than before it reaches the cooler, e.g. a temperature of approximately 200° C. (392′ F.) a conventional regulating valve and conventional pressure units may be used. It is thus possible to avoid the considerable difficulties that would arise if the pressure had to be adjusted on the hot side, i.e. in direct connection with the exhaust gas pipe 6 from the crucible, where the temperature of the exhaust syngas is approximately 800° C. to 1500° C.

As the pressure is adjusted after the cooler 8, this cooler is maintained under pressure and is thus designed to resist any increased pressure in the system. Dust that has been separated is discharged through valves 14,15 at the bottom of the dust separators 16,17.

As mentioned above it is desirable to be able to tap off slag 3 during operation, i.e. whilst the crucible 1 is pressurized. According to the application there is a device for tapping slag for this purpose, which is also pressurized at a pressure corresponding to the pressure in the crucible. The device for tapping slag comprises a horizontal slag channel 18 at the same level as the desired slag height, leading to a descending slag channel 19. The channel 19 is connected to a granulator 20.

In the horizontal channel 18 there is a flooding valve comprising a gate 21 or a board of a suitable material which in its lower end position closes the slag channel between the crucible and the granulator 20 and which in its raised position opens the channel mentioned. The gate 21 is sealed to the walls of the slag channel by means of devices not shown.

When the level of the slag in the crucible reaches the level of the horizontal slag channel 18, the gate 21 will be pushed upwards and slag will run out of the crucible 1 down to the granulator 20. In order to equalize the pressure in the granulator 20 both at this stage and when granulated material is discharged through a valve 23 at the bottom of the granulator, a pressure equalizing pipe 24 which includes a regulating valve 25 is provided. This pipe 24 connects the granulator 20 with the above-mentioned pipe 11, which leads gas away from the crucible 1.

An apparatus according to the present application must, of course, be adapted to the pressures at which it is to be used. Modifications of valves, seals, design of cooler and the like may be made without departing from the main concept of the invention, which is to pressurize both the crucible and the cooler as well as any other auxiliary equipment, for example the tapping devices for slag and molten iron.

### EXAMPLE 2

The drawing of FIG. 2 illustrates one embodiment for carrying out the application in practice.

The apparatus shown in the drawing comprises a substantially sealed and closed electric induction furnace 1 shown diagrammatically and which is provided with a bottom-blowing air supply system represented at 2 for blowing the electrically conductive material 1a disposed within the electric induction furnace with a blowing gas which can be introduced through a pipe 2a. The blowing gas is air. A pipe 2b can add other desirable components to the blowing gas while a cooling-water line 2c provides water to jacket the blowing tubes of the blowing device generally represented at 2.

The level of the electrically conductive material 1a in the converter can be controlled by a receptacle 1b connected to the electric induction furnace below the surface of the electrically conductive material and containing a quantity 1c of the molten metal. A stopper 1d controls transfer of the molten metal between the converter and the receptacle 1d.

The electric induction furnace 1 is provided with an exhaust gas stack generally represented at 3 and connected through the electric induction furnace by a gas pressure gate 3a preventing escape of gases from the electric induction furnace under the superatmospheric pressure at which the latter is operated. The feed fuel is introduced into the electric induction furnace via a hopper 7 and a charging pressure gate 6 which can have a pair of valves 6a and 6b which can be alternately opened to admit the feed fuel from the hopper 6 to the space between the valves 6a and 6b whereupon valve 6a is closed and valve 6b is opened to permit the charge to enter the electric induction furnace.

To prevent escape of gas and to maintain the pressure in the electric induction furnace, a pump 33 supplies gas under pressure via the valve 34 to the gate 6, the excess gas is vented at 35. The exhaust gas stack 3 forms a duct provided with an initial scrubbing system represented diagrammatically at 4. More particularly, the stack is divided into a downwardly extending portion 4e and an upright portion 4f. The downwardly extending portion 4e is provided with a group of spaced apart spray nozzles 4a connected by a manifold 4c to a source 4g of the wash water.

In another portion of the stack or duct, i.e. the upright portion 4f of the stack, is provided another array of nozzles 4b connected to the manifold 4d which is supplied with the scrubbing water.

Downstream of the scrubbing unit 4 there is provided a regulating valve 12 in the form of an annular-gap washer 13. As described in the aforementioned publication, the annular-gap washer can include a cylindrical duct 12c which can be provided with still another scrubbing nozzle 12d and through which the gas is caused to flow. The cylindrical duct 12c terminates at its lower end in a Ventori nozzle 12e, the latter being of the convergent-divergent type, the divergent section receiving a generally conical body 12a which can be displaced on a rod 12f by a servomotor 12d to control the pressure.

From this annular-gap washer 13, the gas is passed upwardly and thence through a duct 40. Pressure-control valves 14 permit bleeding of excess gas to a flaring stack 15 in which the exhaust gas is flared off.

An inlet 30 provided with a valve 30′ can supply a second flow stream of exhaust gas from a remote site such as a second electric induction furnace set (not shown) to the exhaust gas in the duct 40 before the exhaust gas enters the gas accumulator 11 via the connecting duct 10 and a pressure control valve 10a. The gas accumulator 11 can be formed with a flexible membrane 16a so that the compressed gas in the compartment 16, e.g. nitrogen, will not mix with the washed and scrubbed exhaust gas from the converter.

A nitrogen source 17 connected by a pressure control valve 17a and a throttle valve 17b with the chamber 16 of the accumulator to pressurize the latter and drive the exhaust gas to the energy utilization stage. A duct 18 leads from the gas accumulator 11 and is provided with an inlet 31 having a valve 31′ for second flow stream of exhaust gas used to augment the heat value of the exhaust gas. A valve 41 controls the quantity of the exhaust gas which is bled to an expansion turbine driving the generator 23′ in the manner described in the aforementioned publication. Second flow stream of exhaust gas may be of similar chemical composition as the original exhaust gas or may have its CO, H.sub.2 or both gas content adjusted prior to introduction to inlet 31. The exhaust gas, can be introduced into a combustion chamber 20 to which air is supplied by a compressor 22 to facilitate combustion of the exhaust gas in the combustion chamber.

The compressor 22 is, in turn, driven by a gas turbine 21 powered by the high velocity gases emerging from the combustion chamber. An electrical generator 23 is coupled to the shafts of the turbine 21 (so as to be driven thereby) and the compressor 22. Both generators 23 and 23′ can be connected to a single network.

From the aforegoing it will be apparent that the electric induction furnace set of the present application includes an electric induction furnace unit with a device 2 for the blowing of fresh gas through the melt (bottom-blowing nozzles), a exhaust gas stack 3 and a washing device 4 for the converter exhaust gases.

According to the invention, however, the electric induction furnace is formed as a substantially sealed or closed reaction vessel with a gate 6 for introducing the feed fuel from the hopper 7. The electric induction furnace is also provided with a slag-removal device represented generally at 8 and a melt recovery device represented generally at 9 to recover at least a portion of the electrically conductive material disposed within electric induction furnace reaction vessel. The slag removal device 8 comprises an upright cylinder 8b communicating from above with the top of the duct 9b leading to the charge tap 9c which can be selectively blocked or unblocked whenever the electrically conductive material is to be recovered or tapping of the electric induction furnace is desirable for some other purpose. The slag separator consists of an upright vessel 8b in which a plug 8a is displaceable.

The system also includes a exhaust gas stack 3 having an integrated wet-washing or scrubbing installation and connected to the reaction vessel 5. A connecting duct 10 connects the scrubbing units to the gas accumulator 11. In the wet-washing or scrubbing units 4 and/or in the connecting duct between the scrubbing device 4 and the gas accumulator 11, there is provided at least one control valve 12 which enables the pressure to build up behind the valve and hence in the electric induction furnace. It has already been mentioned that the scrubbing device 4 includes the annular-gap washer, e.g. of the aforementioned publication, serving simultaneously as the control valve 12. It is within the framework of the present application to provide pressure-retaining valves 14 which enable the flaring chimney to operate efficiently, i.e. burnoff of gas.

The stack 13 is also useful when the gas supplied exceeds that which can be successively stored in the accumulator 11 in above or underground storage. The apparatus aspects of the present application involve the provision of the gas accumulator 11 with a volume such that it is capable of storing the exhaust gases generated over a determined time period.

The accumulator 11 stores the scrubbed exhaust gas in force-transmitting relationship with a nitrogen cushion operated by the nitrogen storage source 17. The gas can be continuously withdrawn from the accumulator 11. The gas withdrawn from the accumulator 11 is fed via line 18 to the gas consumer device. In the gas consumer device, at least part of the gas is burned, e.g. for recovery of energy in a boiler. Note that the term gas consumer device means a downstream set of equipment or plant or both.

The duct 18 is connected via a valve 41 with the expansion turbine 19 discharging into the atmosphere. When the expansion turbine 19 is driven, generator 23′ is engaged. The gas from the accumulator 11 can also be introduced into a combustion chamber 20. In the embodiment illustrated, the gas turbine 21 drives the axial compressor 22 which supplies compressed air to the combustion chamber 20. The combustion products driving the turbine 21 thus also operate a generator 23 connected thereto.

In another embodiment of the present invention, the exhaust gas is diverted from line 18 to a gas consumer device comprising a synthesis gas burner configured within a combustion furnace-boiler set (not shown) for combustion of the exhaust gas and the generation of steam to drive a steam turbine coupled with a generator for electric power generation. In yet another embodiment of the present invention, exhaust gas is diverted from line 18 to a gas turbine set for generation of electric power, the gas turbine exhaust is diverted to a steam-cycle turbine set for generation of electric power in a combined cycle power configuration. In yet another embodiment of the present application the exhaust gas from line 18 is fed into a suitable fuel cell for direct generation of electric power.

In another mode of the present invention, the exhaust gas from line 18 may be deployed and piped to a second reaction plant for conversion of the exhaust gas into Fischer-Tropsch (“F-T”) products, hydrocarbons, commodity chemicals, or derivatives thereof, or combinations thereof.

In another embodiment of the present invention, the exhaust gas is diverted from line 18 to a downstream syngas unit comprising a synthesis gas burner configured within a combustion furnace-boiler set (not shown) for combustion of the syngas and the generation of steam to drive a steam turbine coupled with a generator for electric power generation. In yet another embodiment of the present invention, syngas is diverted from line 18 to a gas turbine set for generation of electric power, the gas turbine exhaust is diverted to a steam-cycle turbine set for generation of electric power in a combined cycle power configuration. In yet another embodiment of the present application the syngas from line 18 is fed into a suitable fuel cell device for direct generation of electric power.

### EXAMPLE 3

In the gasifier furnace with stationary single phase coils, FIG. 3, a coil 1 with one winding is traversed by an alternating current of a frequency determined by the source of power. The alternating current inside the coil causes the appearance of induced currents in the bath 2 contained in the crucible 3.

If the furnace is of cylindrical symmetry, the magnetic field is axial in a first approximation, i.e. its axial component H ζ is predominate. Nevertheless, in the upper and lower parts of the charge (FIG. 3), the magnetic field has a non-negligible radial component H ρ.

It is known that this component H ρ causes the appearance of turbulence within the metal in the molten state in the crucible. In fact, the simultaneous presence at one point of the molten metal of an induced current density represented by a vector J and of a magnetic field represented by a vector H (the conjugate of this vector is designated by H* hereinafter), causes the appearance of a volume force F described by:

F=μRe{J×H*}

where μ is the magnetic permeability and Re (J×H*) is the real part of the vector (J×H*).

It is known that in single phase coil induction-gasifier furnaces, such as the one shown in FIG. 3, W is zero or weak at the midheight of the molten bath and its tangential component W θ (which is the only one different from zero) increases toward the lower and upper end of the bath, with a different sign in each of the halves.

The sign is different, because in the case of single phase coils H* has opposing signs in the two halves and the first term of equation (1) is preponderant with respect to the second.

In another embodiment of the invention, the gasifier is configured to hold a molten metal melt within a gasifier container (or sometimes referred to as a crucible) device, the gasifier arranged with one or more induction coil apparatus supplied with three phase alternating current (A.C.) power of a desired frequency range so as to cause a desired penetration depth within the molten metal melt.

The reference depth is the theoretical minimum depth of induction coil driven heating of the molten metal melt that a desired frequency will produce at a given power and molten metal melt temperature. The cross-sectional size of the molten metal melt being heated must be at least 4 times the reference depth, or current cancellation will occur, also, the current density decreases exponentially as the distance from the surface increases towards the center. A higher frequency will keep the current density concentrated closer to the surface. This in turn will drastically decrease the cross-sectional area of the active current flow, thus drastically increasing the resistance.

As a rule of thumb, the reference depth is the depth where 86% of heating occurs from eddy currents and resistivity.

Feed is supplied and delivered into contact with the molten metal melt to cause at least a portion of the feed to be dissolved within the molten metal melt and at least a portion of the feed to be converted into syngas (synthesis gas).

The gasifier and its related parts may be arranged such as the plant depicted in FIG. 1, FIG. 2, or deviations and combinations thereof.

In the induction-gasifier furnaces using a three phase coil with a progressing field, three coils (FIG. 4) are connected for example with a tri-phase system of U R, U S, and U T (FIG. 3) and traversed by the currents I S, I R and I T, out of phase by 120° with respect to each other.

These currents develop a magnetic field which depends on the geometric disposition of the coils and of the magnetic sheet metal cores to guide the flux, the latter not shown. The magnetic field has a preponderant progressive wave component. This progressive wave of the magnetic field moves toward the top or the bottom, depending on the order of succession of the phase R, S and T.

It is known that a progressive magnetic field creates a vortex W with a tangential component W θ (the only one of interest, because in principle W ρ and W ζ are zero) having the same sign throughout the bath of molten metal.

In one embodiment the desired A.C. power waveform frequency is between 500 Hz to 1600 Hz. In one embodiment the desired A.C. power waveform frequency is between 300 Hz to 2000 Hz. In one embodiment the desired A.C. power waveform frequency is between 1000 Hz to 1800 Hz.

In one embodiment the desired A.C. power waveform frequency is between 250 Hz to 1700 Hz.

In one embodiment the desired A.C. power waveform frequency is between 50 Hz to 1400 Hz.

In one embodiment the desired A.C. power waveform frequency is between 100 Hz to 800 Hz.

In one embodiment the desired A.C. power waveform is single phase. In another embodiment the desired A.C. power waveform is three phase.

One or more power control circuit, one or more power supply circuit is operatively in communication with at least one induction coil that is arranged within the gasifier, crucible or a combination.

In one non-limiting example, the power control circuit is herein disclosed, wherein one object of the application is to avoid damages to the thyristors (or some other power switching semiconductor component) and to enable start and operation of an inverter system under no or light load.

In one example, the power control circuit is configured and arranged as a series resonant inverter circuit (also called the series resonant converter (SRC)), and outputs a desired A.C. power waveform of a desired waveform frequency and phase. In the simplest circuit topology, it consists of a series combination of an inductor (induction coil), capacitor, and a lossy resistance. The resistance is the combination of losses from the molten metal melt, resistance of the work coil, internal ESR of the capacitor, and any system losses.

In one non-limiting example, a capacitor is connected electrically in series with one or more induction coil arranged with the gasifier, crucible or in combination, and a phase-locked loop keeps the power supply operating at the resonant frequency of the one or more induction coil and capacitor. Operation at resonance is detected by comparing the phases of the driving voltage and the voltage across the capacitor, the phases of these voltages being in quadrature at resonance. A voltage controlled oscillator is controlled by a signal corresponding to the deviation of the phases from quadrature.

In another example, the power control circuit is configured and arranged as a parallel resonant inverter circuit (also called parallel resonant converter (PRC)), and outputs a desired A.C. power waveform of a desired waveform frequency and phase, in the simplest form and as the counterpart to the voltage-source series resonant converter, the current-source parallel resonant converter has the same components connected in parallel branches.

In one non-limiting example, and with reference to FIG. 9, a full-bridge PRC circuit is shown in FIG. 9. Inductor L and capacitor C form the parallel resonant circuit. A MOSFET bridge inverter excites the resonant circuit with a square wave voltage. Voltage across C is rectified and filtered using an LC filter to get the required DC output voltage.

In yet another example, the power control circuit is configured and arranged as a series parallel resonant inverter circuit, and outputs a desired A.C. power waveform of a desired waveform frequency and phase.

According to one aspect of the invention, there is provided a method of controlling an inverter of a load commutation type, having arms formed of thyristors, in which pulses are produced and distributed through a distributor to the gates of the thyristors for performing, under normal circumstances, constant margin time control or constant margin angle control, the method comprising the steps of:

Load Detection:

detecting the voltage across the load,

comparing the magnitude of the detected voltage with a predetermined level,

producing a pulse when the magnitude of the detected voltage exceeds the predetermined level, and

delivering the pulse through the distributor to the gates of the thyristors.

According to another aspect of the invention, there is provided a control system for an inverter of a load commutation type, the inverter having arms formed of thyristors, the control system comprising:

detecting means for detecting the voltage across the load;

Control Algorithm:

control circuit responsive to the detected voltage for producing pulses for performing constant margin time control or constant margin angle control,

a distributor responsive to the pulses from the commutation control circuit for distributing the pulses to the gates of the thyristors, and

comparing means for comparing the magnitude of the detected voltage with a predetermined level and producing a pulse when the magnitude of the detected voltage exceeds the predetermined level,

the distributor being also responsive to the pulses from the comparing means for distributing the pulses from the comparing means to the gates of the thyristors.

With reference to FIG. 5, a comparator 10 receives the output 7a of the rectifier 7, which is indicative of the magnitude of the detected voltage. The comparator 10 also receives a voltage 9a of a predetermined reference value from a voltage reference generator 9.

A logic circuit 11 is connected to receive the output of the voltage detector 6, and the pulses from the control circuit 5 and the comparator 10, and permits passage of the pulse from either the control circuit 5 or the comparator 10 whichever is the earlier to supply the pulse during each half cycle of the voltage across the load 4.

The logic circuit 11 may, for example, have an internal construction as shown in FIG. 5. As illustrated, it comprises a zero crossing detector 31 which receives the output 6a of the detector 6 and produces a pulsative output 31a when the output 6a crosses the zero level. A set-reset type flip-flop circuit 32 receives, as the set input S, the pulse 31a and is therefore set when each half cycle of the voltage across the load 4 begins.

The Q output 32a of the flip-flop circuit 32 is applied to one input of an AND gate circuit 33. The output of the OR gate circuit 34 is also applied through a delay circuit 35 to the reset input R of the flip-flop circuit 32, thereby to reset the flip-flop circuit 32.

The output 32a of the flip-flop circuit 32 is therefore at a high level until a little time after the first appearance, during each half cycle, of a pulse at the output of the OR gate circuit 34. The pulse 5a or 10a which is the first to appear, during each half cycle, at the output of the OR gate circuit 34 is thus allowed to pass through the AND gate circuit 33.

Any pulse which subsequently appears during the same half cycle is blocked by the AND gate circuit 33, since the flip-flop circuit 32 has been reset by the time such subsequent appearance of the pulse takes place.

With reference to FIG. 3A, the induction-gasifier crucible furnace, comprising an inductor, magnetic yokes and a body or housing of a pressure-tight vessel with a cover. The inductor and the magnetic yokes are fastened to an intermediate jacket, and the magnetic yokes are pressed radially to the inductor by means of fasteners passing through the intermediate jacket.

The intermediate jacket with the inductor and magnetic yokes inside it is disposed inside the body of the pressure-tight vessel and is fastened rigidly by means of a ring at its upper end to the flange of the body of the pressure-tight vessel. The space between the inductor, the magnetic yokes, the intermediate jacket and the body of the pressure-tight vessel is filled with refractory material.

The diameter of the flange of the body of the pressure-tight vessel is larger than that of the carrying ring of the intermediate jacket, and to the same flange there is fastened a seal between it and the cover. The diameter of the seal is also larger than the diameter of the carrying ring. The fasteners for pressing the magnetic yokes to the inductor are the bolts of a screw-type joint connected with the intermediate jacket.

The inductor 1 and the magnetic yokes 25 are fastened inside the intermediate jacket 3. The magnetic yokes 25 are pressed radially against the inductor 1 by means of fasteners 26, which pass through the intermediate jacket 3. The fasteners 26 represent the bolts of a screw-type joints with the intermediate jacket 3.

The magnetic yokes 25 are electrically insulated from the inductor 1 by means of insulating gaskets 27. The inductor 1 and the magnetic yokes 25 are fixed axially with respect to the intermediate jacket 3 by the floor refractory 11 and the top refractory 21, being pressed by the cover 24, which is fastened to the intermediate jacket 3 by means of bolts 23.

The intermediate jacket 3 with the attached inductor 1 and magnetic yokes 25 is disposed inside the body of the pressure tight vessel 10 and is fastened rigidly by means of the carrying ring 7 in its upper end and bolts 6 to the flange 9 of the body of the pressure-tight vessel 10. Inside the inductor 1, the floor refractory 11 and the top refractory 21 there is rammed the crucible 2 which receives the melt 12.

The outlets 19 of the furnace are connected to the inductor 1 by means of water-cooled electric connections 13. The seals between the outlets 19 and the through plate 20 are pressed by means of the nuts 17. The seal 16 between the plate 20 and the flange 14 of the body of the pressure-tight vessel 10 is pressed by means of bolts 18.

The space between the inductor 1, the magnetic yokes 25, the intermediate jacket 3 and the body of the pressure-tight vessel 10 is filled with refractory material 28. In the carrying ring 7 there are bored holes 4 for pouring-in refractory material 28, and in the same holes 4 there are provided gas-permeable filters 5.

Flange 9 of the body of the pressure-tight vessel 10 has a diameter which is larger than that of the carrying ring 7 of the intermediate jacket 3, and to the same flange 9 there is fastened the seal 8 between it and the cover 22. The diameter of seal 8 is also larger than the diameter of the carrying ring 7.

The gasifier crucible furnace in accordance with the application is loaded with material to be subjected to melting; it is then closed tightly by cover 22. Then it is evacuated or filled with pressurized gas, through cover 22 for example, and at the same time the furnace is connected to the electric mains by means of the outlets 19, as in known furnaces of this type.

The design of the furnace, unlike the known ones, provides a possibility for the case of an eventual piercing of crucible 2, for the liquid metal 12 which is under pressure, to reach only the refractory 28 and there to solidify, without coming in contact with the body 10.

In one non-limiting example, and with reference to FIG. 6, shows a furnace 1, designed as a vertical gasifier, fitted with a refractory lining 2 in the interior. Via an overhead lance device (not shown), carbonaceous feedstock, such as carbon or material containing carbon, as well as oxidizing gasification agents such as air or oxygen and, if necessary, slag-inducing constituents are introduced at metal bath 4 situated in the furnace 1 and having a layer of slag 5 situated thereon.

In its upper areas free of any contact with the molten metal bath, the furnace 1 is equipped with a gas discharge 6. This discharges into a movable gas discharge channel 7 which is connected to a stationary gas discharge line 10 at the connection locations 8 and 9 so as to be easily releasable.

Furnace 1 is provided with a slag discharge drain 12 arranged at the wall 11, said nozzle 12 discharging into a second chamber 13 situated below it or being directly connected to a device for the de-sulphurization and preparation of the slags.

When required, this slag discharge nozzle 12 can he closed by means of a refractory/sand plug. Further, the furnace 1 is provided at both sides with pivot pins 14, 16 which are held so as to be tiltable and rotatable in bearings 15, 17.

During operation of the furnace 1, the carbon containing feed, as wet as partially oxidizing gasification agents consisting of gases containing oxygen and if necessary, slag-forming constituents are introduced in a suitable form, for example, in a fine-granular or pulverized form given solids, through the nozzles (not shown) from the top free space into the molten metal 4 in the first chamber. The molten metal 4 consist of Fe alloy of a carbon content of a desired amount, and is inductively heated by means of electric induction cot arranged in helical fashion at 21 and 22 around the first chamber of furnace 1.

The sulfur present in the carbon or in the carbon carrier is absorbed by the basic slag 5 situated on the metal melt 4, so that a high-grade product syngas can be removed from the furnace 1 via the gas discharge channel 6 in the direction of arrows 18, 19.

The slag 5 containing sulfur or a part of said slag is drawn off from time to time, after a corresponding saturation with sulfur, through the discharge drain 12 into the second chamber 13.

Typical composition of the syngas may be summarized as follows:

Run A:

| CO | H2 | CO2 | O2 | N2 | CH4 | |
|---|---|---|---|---|---|---|
| 65.17 | 32.6 | 0.6 | 0.5 | 1.1 | 0.03 | (%) |

Run B:

| CO | H2 | CO2 | O2 | N2 | CH4 | NH3 | CxHy | SO2 | H2S |
|---|---|---|---|---|---|---|---|---|---|
| 34.9 | 60.6 | 0.83 | 0.64 | 1.4 | 0.02 | TRACE | TRACE | <4 | <3 |
| | | | | | | | | ppm | mg/nm3 |

If, during the operation of the furnace 1, the refractory lining should require servicing or otherwise malfunction, the furnace 1 may, using the present inventive arrangement, be inclined until the identified refractory layer zone is free from the metal melt 4. The movable gas discharge channel 7 is lifted off from the connection locations 8 and 9, so that the reactor 1 can be freely swiveled around the pivot pins and bearings 14, 15, 16, 17.

In the illustrated example, a sand seal (also indicated at 8 and 9) is provided, which seal is filled with a loose fill of sand gained by comminuting of fireproof ceramic.

The refractory of the gasifier is made from high purity magnesite, the high purity carbon, and the low levels of metal addition. In other embodiments the gasifier is configured with a crucible that is made of a metal material, a refractory material, or a combination.

In yet another embodiment of the present invention, the interior or at least a portion of the interior of the gasifier is made of a metal or its alloy, such as steel, copper, titanium, tungsten, or deviations, such as stainless steel, Inconel, steel alloys, etc.

The metallic interior of the gasifier, or a metallic crucible of the gasifier is arranged to hold a molten metal melt within, the gasifier is further arranged with one or more induction coil each supplied with an alternating current (A.C.) power at a desired A.C. power waveform frequency.

In one embodiment the desired A.C. power waveform frequency is between 50 Hz to 250 Hz. In one embodiment the desired A.C. power waveform frequency is between 50 Hz to 350 Hz. In one embodiment the desired A.C. power waveform frequency is between 50 Hz to 500 Hz.

In one embodiment the desired A.C. power waveform frequency is between 50 Hz to 700 Hz.

In one embodiment the desired A.C. power waveform frequency is between 100 Hz to 250 Hz.

In one embodiment the desired A.C. power waveform frequency is between 100 Hz to 700 Hz.

In one embodiment the desired A.C. power waveform is single phase. In another embodiment the desired A.C. power waveform is three phase.

Based on the selection of range 50 Hz to 1000 Hz, or even better at narrower frequency ranges of 100 Hz to 800 Hz, or 150 Hz to 600 Hz, the application provides a preferable melt viscosity of the molten metal due to electromagnetic resonance, and within this range, electromagnetic stirring promotes agitated mixing between feed and the molten metal reducing feed residency time during syngas generation. Other useful ranges are 50 Hz to 4 kHz, or 300 Hz to 6 kHz, or 120 Hz to 4.8 kHz, or a combination thereof. The excitation is provided to cause molten metal to have an operating temperature range of between 900 degrees Celsius to 2,000 degrees Celsius.

The recirculation of exhaust gases from the slag granulating step is implemented in an improved way during inductive heating of the molten metal within the gasifier at the mentioned inductive heating frequency ranges, so as to provide a target range of molten metal fluid viscosity, and the rate of slag withdrawn is further controlled by regulating the temperature of the cooling fluid—which is used for slag cooling—to be within the designated temperature range.

In Run “A” and Run “B”, the resultant syngas is within a specified target quality and composition based on the improved inductive heating frequency applied to the molten metal and the resultant viscosity of the withdrawn slag that generates the intended slag exhaust gas that is re-circulated within the gasifier.

Higher inductive frequencies that is beyond the specified ranges have non-optimal result on the fluid behavior of the molten metal and non-recirculation of the slag exhaust gas does not result in the gas compositions and specified target quality of Run “A” and Run “B”.

1-8. (canceled)

9. A process for gasification of feed fuel material into syngas, comprising;
(a) electric induction melting of a metal into a melt disposed within a crucible;
(b) delivering feed fuel material into contact with at least a portion of the melt to convert at least a portion of feed fuel material into syngas and molten slag;
(c) withdrawing molten slag from the crucible and placing molten slag into contact with a cooling fluid to form a granulated slag material; and
(d) varying the electric induction melting frequency to a desired frequency band and controlling the temperature of the cooling fluid to a desired range temperature during (c) to cause a desired fluid behaviour of the melt and a desired viscosity of the molten slag.

10. The process for gasification of claim 9, wherein desired frequency band during (d) is between 50 Hz to 700 Hz.

11. The process for gasification of claim 9, wherein desired range temperature during (d) is between 15 to 40 degrees Celsius.

12. The process for gasification of claim 9, wherein the syngas H₂ to CO ratio is at least 2:1 during (d).
